(19) United States
(12) Patent Application Publication
(10) Pub. No.: US 2015/0158157 A1
(43) Pub. Date: Jun. 11, 2015

(54) ELECTRIC POWER TOOL

(71) Applicant: MAKITA CORPORATION, Anjo-shi, Aichi (JP)

(72) Inventors: Tokuo Hirabayashi, Anjo-shi (JP); Ryunosuke Kumagai, Anjo-shi (JP); Takeshi Nishimiya, Anjo-shi (JP); Goshi Ishikawa, Anjo-shi (JP); Takuya Kusakawa, Anjo-shi (JP)

(21) Appl. No.: 14/405,285

(22) PCT Filed: May 31, 2013
(86) PCT No.: PCT/JP2013/065243

§ 371 Date: Dec. 3, 2014

(30) Foreign Application Priority Data
Jun. 5, 2012 (JP) 2012-128230

(51) Int. Cl. B25B 23/00; B25B 21/00

(52) U.S. Cl. CPC B25B 23/0064; B25B 21/00

(57) ABSTRACT

An electric power tool to tighten a screw while drilling a hole with the screw in a tightening-target-object includes a motor as a drive source. A motor control unit controls the motor such that the rotation number of the motor is a rotation number according to specifics of an operation input received by an operation receiving unit with a preset maximum rotation number as an upper limit. At a start-up of the motor, the maximum rotation number is set to a first maximum rotation number. When it is detected that a hole has been drilled in the tightening-target-object with the screw after the start-up of the motor, the maximum rotation number is set to a second maximum rotation number lower than the first maximum rotation number. The second maximum rotation number is set according to a material thickness so as to become lower as the material thickness is smaller.

### CROSS-REFERENCE TO RELATED APPLICATIONS

This international application claims the benefit of Japanese Patent Application No. 2012-128230 filed Jun. 5, 2012 in the Japan Patent Office, and the entire disclosure of Japanese Patent Application No. 2012-128230 is incorporated herein by reference.

### TECHNICAL FIELD

The present invention relates to an electric power tool that is rotationally driven by a motor.

### BACKGROUND ART

Screws that can be tightened with an electric power tool include a known screw, such as a self-drilling screw or a wood screw having a drill-shaped point, which can be tightened while the screw itself is drilling a hole in a tightening-target-object, such as a steel plate (see, for example, Patent Document 1).

When performing a tightening operation of such a screw with an electric power tool, an operator strikes a point of the screw against the tightening-target-object and pulls a trigger switch of the electric power tool while pressing a screw head toward the tightening-target-object with a tool bit. Then, the screw is rotated at a rotation number in accordance with a pulled amount of the trigger switch with a set rotation number (a maximum rotation number) which is set previously as an upper limit, and is tightened while drilling a hole in the tightening-target-object. In a case of a self-drilling screw, a hole is drilled with a drilling portion at the screw point, and thereafter the screw is tightened while the screw itself is tapping into the tightening-target-object. The rotation number of the electric power tool is increased as the pulled amount of the trigger switch is increased, and reaches the set rotation number when the trigger switch is pulled by a specified amount or more.

Some electric power tools provide a mode for appropriately tightening a self-drilling screw. A typical self-drilling screw is a TEKS (Registered Trademark, hereinafter the same applies) screw. Therefore, in cases where the aforementioned mode for tightening a self-drilling screw is included in a plurality of modes (functions) provided by an electric power tool, the aforementioned mode is sometimes called a “TEKS mode”.

### PRIOR ART DOCUMENTS

### Patent Documents

Patent Document 1: Japanese Unexamined Patent Application Publication No. 2010-207951

### SUMMARY OF THE INVENTION

### Problems to be Solved by the Invention

A type of screw, such as the aforementioned self-drilling screw, is basically configured to first drill a hole in a tightening-target-object without a hole, to which the screw is tightened. Accordingly, it is preferable that the set rotation number of an electric power tool is large in order to surely and rapidly drill a hole in the tightening-target-object.

However, when the set rotation number is large, it might be impossible to appropriately tighten a screw according to the thickness of the tightening-target-object. The thickness of the tightening-target-object means a thickness in a screw tightening direction, which is hereinafter also referred to as the “plate thickness”. In a case where the tightening-target-object is a plate-like object, a user usually tightens a screw in a perpendicular direction to a plate surface, and thus the plate thickness is a length in the perpendicular direction.

When the user performs tightening of a self-drilling screw or the like into the tightening-target-object having a small plate thickness at a large set rotation number, the screw immediately penetrates the tightening-target-object due to the small plate thickness. In this case, unless the user releases the trigger switch immediately after the penetration to stop rotation of the screw, the screw may idle at high speed and cause problems, such as damage of a screw hole in the tightening-target-object.

To avoid such problems, the user is required to perform tightening at a lower set rotation number. However, tightening at a lower set rotation number results in a longer time required for tightening. Particularly, in a case where the plate thickness of the tightening-target-object is larger, the screw cannot easily enter the tightening-target-object, resulting in a longer entire operation time.

In the present invention, it is desirable to allow, in an electric power tool for tightening a screw into a tightening-target-object while drilling a hole in the tightening-target-object with the screw, appropriate tightening of the screw into the tightening-target-object regardless of the thickness of the tightening-target-object, to thereby achieve an improved workability.

### Means for Solving the Problems

In one aspect, the present invention is an electric power tool to tighten a screw while drilling a hole with the screw in a tightening-target-object. The electric power tool includes a motor, an operation receiving unit, a material thickness receiving unit, a motor control unit, a first maximum rotation number setting unit, a hole drilling detection unit, a second maximum rotation number setting unit, and a second maximum rotation number variable setting unit.

The motor rotationally drives an output shaft on which a tool element is mounted. The operation receiving unit receives an external operation input to rotate the motor. The material thickness receiving unit receives a material thickness that is a thickness of the tightening-target-object. The motor control unit controls the motor such that the motor rotates at a rotation number according to specifics of the operation input received by the operation receiving unit with a preset maximum rotation number as an upper limit. The first maximum rotation number setting unit sets the maximum rotation number to a specified first maximum rotation number at a start-up of the motor. The hole drilling detection unit detects that a hole has been drilled in the tightening-target-object with the screw after the start-up of the motor. The second maximum rotation number setting unit sets, when it is detected by the hole drilling detection unit that a hole has been drilled, the maximum rotation number to a specified second maximum rotation number that is smaller than the first maximum rotation number. The second maximum rotation number variable setting unit sets the second maximum rotation number according to the material thickness such that the second maximum rotation number becomes lower as the material thickness received by the material thickness receiving unit is smaller.

Here, “rotation number” means rotation number per unit time, that is, rotation speed (hereinafter the same).

In the electric power tool of the present invention configured as above, the second maximum rotation number is set to a lower value as the plate thickness is smaller. Accordingly, when the material thickness is small, the rotation number after a hole has been drilled is suppressed low, which can inhibit occurrence of defects in the tightening-target-object. In reverse, when the material thickness is large, a decrease amount in the rotation number after a hole has been drilled is relatively small, which can avoid prolongation of operation time.

According to the electric power tool of the present invention, therefore, it is possible to perform a tightening operation of a screw into a tightening-target-object regardless of the material thickness of the tightening-target-object, and to thereby achieve an improved general workability.

When the tightening operation continues after a hole is drilled in the tightening-target-object, the screw is eventually seated on the tightening-target-object. Once the screw is seated, the rotation number may be further decreased. Specifically, there is preferably provided a seating detection unit configured to detect that the screw rotated by the tool element has been seated on the tightening-target-object, and the motor control unit stops the motor when it is detected by the seating detection unit that the screw has been seated after the start-up of the motor.

By stopping the rotation of the motor once the screw has been seated as described above, it is possible to inhibit the screw from being tightened with an excessively large force after the seating, to thereby finish the tightening operation in a proper state.

Alternatively, the motor may be operated at a lower rotation number instead of being stopped once the screw has been seated. Specifically, there is preferably provided a third maximum rotation number setting unit configured to set, when it is detected by the seating detection unit that the screw has been seated after the maximum rotation number is set to the second maximum rotation number, the maximum rotation number to a specified third maximum rotation number that is lower than the second maximum rotation number.

By further decreasing the maximum rotation number once the screw has been seated as described above, it is also possible to inhibit the screw from being tightened with an excessively large force after the seating, to thereby finish the tightening operation in a proper state.

The third maximum rotation number also may be variably set according to the material thickness. Specifically, there is preferably provided a third maximum rotation number variable setting unit configured to set the third maximum rotation number according to the material thickness such that the third maximum rotation number becomes lower as the material thickness received by the material thickness receiving unit is smaller.

By setting the third maximum rotation number such that the third maximum rotation number becomes lower as the plate thickness is smaller, it is possible to improve the workability and also to achieve a more appropriate finishing state regardless of the material thickness.

The first maximum rotation number also may be variably set according to the material thickness. Specifically, there is preferably provided a first maximum rotation number variable setting unit configured to set the first maximum rotation number according to the material thickness such that the first maximum rotation number becomes lower as the material thickness received by the material thickness receiving unit is smaller.

By setting the first maximum rotation number in an early stage at the time of start-up such that the first maximum rotation number becomes lower as the plate thickness is smaller, it is possible to improve the workability and also to surely inhibit occurrence of defects in the tightening-target-object after a hole has been drilled therein especially in a case where the plate thickness is small.

### BRIEF DESCRIPTION OF THE DRAWINGS

FIG. 1 is a perspective view showing an appearance of an electric power tool according to an embodiment.

FIG. 2 is a block diagram showing a configuration of an entire drive system of the electric power tool.

FIGS. 3A-3B are explanatory views showing correspondence relationships between the plate thickness and each of respective set rotation numbers N1, N2, and N3, and each of respective rotation number thresholds Ns1 and Ns2.

FIG. 4 is a flowchart showing a motor control process to be executed by a controller.

FIG. 5 is an explanatory view showing an example of changes in a set rotation number and in actual rotation number of a motor (an example of stopping the motor at the time of seating) during an operation in a TEKS mode.

FIG. 6 is an explanatory view showing an example of changes in a set rotation number and in actual rotation number of a motor (an example of decreasing the set rotation number at the time of seating) during an operation in the TEKS mode.

FIG. 7 is an explanatory view showing a modified example of correspondence relationships between the plate thickness and each of the respective set rotation numbers N1, N2, and N3, and each of respective rotation number thresholds Ns1 and Ns2.

### EXPLANATION OF REFERENCE NUMERALS

1 . . . electric power tool, 2, 3 . . . housing half, 4 . . . handle portion, 5 . . . main body housing, 6 . . . battery pack, 7 . . . motor housing portion, 8 . . . sleeve, 9 . . . lighting LED, 10 . . . trigger switch, 11 . . . forward/reverse changeover switch, 12 . . . mode switching ring, 13 . . . arrow, 14 . . . battery, 16 . . . first changeover switch, 17 . . . second changeover switch, 20 . . . motor, 30 . . . operation and display panel, 31 . . . controller, 32 . . . gate circuit, 33 . . . motor drive circuit, 34 . . . rotational position sensor, 35 . . . shunt resistor, 36 . . . regulator, 41 . . . plate thickness input and display unit, 51 . . . CPU, 52 . . . ROM, 53 . . . RAM, 54 . . . flash memory.

### MODE FOR CARRYING OUT THE INVENTION

Hereinafter, a preferred embodiment of the present invention will be described with reference to the drawings.

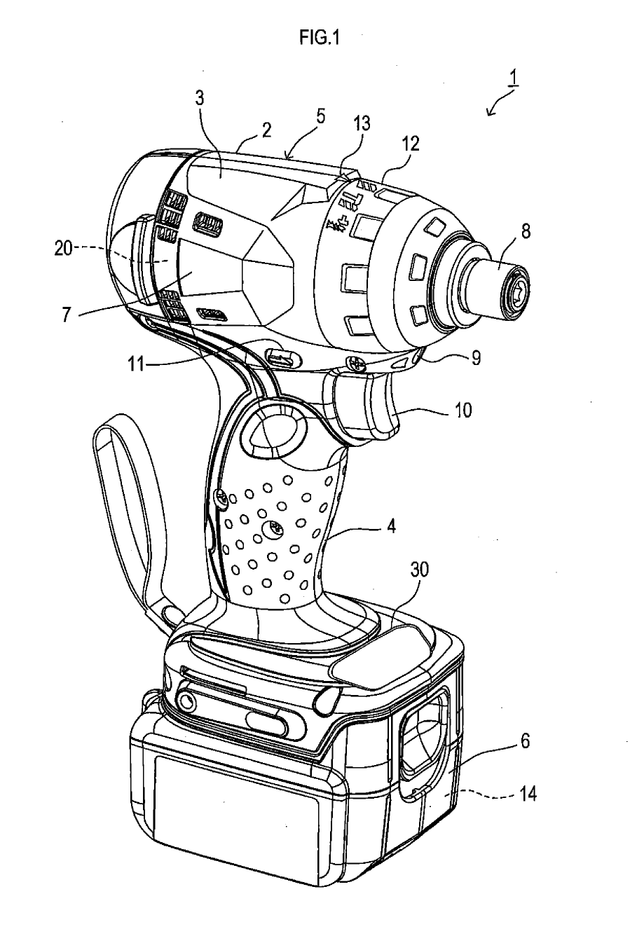

As shown in FIG. 1, an electric power tool 1 according to the present embodiment is a rechargeable 5-mode impact driver that is operable in five operation modes.

More specifically, the electric power tool 1 includes a main body housing 5 and a battery pack 6. The main body housing 5 is formed by assembling housing halves 2 and 3 together. A handle portion 4 is extendingly provided in a lower part of the main body housing 5. The battery pack 6 is attached to a lower end of the handle portion 4 in a detachable manner.

A motor housing portion 7 to house a motor 20, which is a drive source of the electric power tool 1, is provided in a rear part of the main body housing 5. A plurality of types of transmission mechanisms (not shown) for transmitting rotation of the motor 20 to a tool tip are housed forward of the motor housing portion 7. A sleeve 8 for attaching thereto a not-shown tool bit (e.g., a driver bit), which is an example of a tool element, is protrusively provided at a front end of the main body housing 5.

At an upper front side of the handle portion 4 in the main body housing 5, there is provided a trigger switch 10. The trigger switch 10 is operable in a state where a user (operator) of the electric power tool 1 grips the handle portion 4 in order to rotationally drive the motor 20 to thereby operate the electric power tool 1. At an upper center part above the handle portion 4 in the main body housing 5, there is provided a forward/reverse changeover switch 11 to switch a rotational direction of the motor 20.

Also, in a front part of the main body housing 5, there is provided a mode switching ring 12 to be turned (displaced) by a user in order to set the electric power tool 1 to one of the operation modes.

The mode switching ring 12 is a ring-shaped member that is disposed substantially coaxially with an axis of the sleeve 8 in the front part of the main body housing 5 so as to be turnable around the axis. Five marks indicating the respective five types of operation modes are disposed sequentially in a circumferential direction in a partial region of a surface of the mode switching ring 12. At a rear side of the mode switching ring 12 on a top surface of the main body housing 5, there is provided a triangle-shaped arrow 13.

By turning the mode switching ring 12 to adjust a mark for a desired operation mode to a tip of the arrow 13, a user of the electric power tool 1 can operate the electric power tool 1 in the desired operation mode.

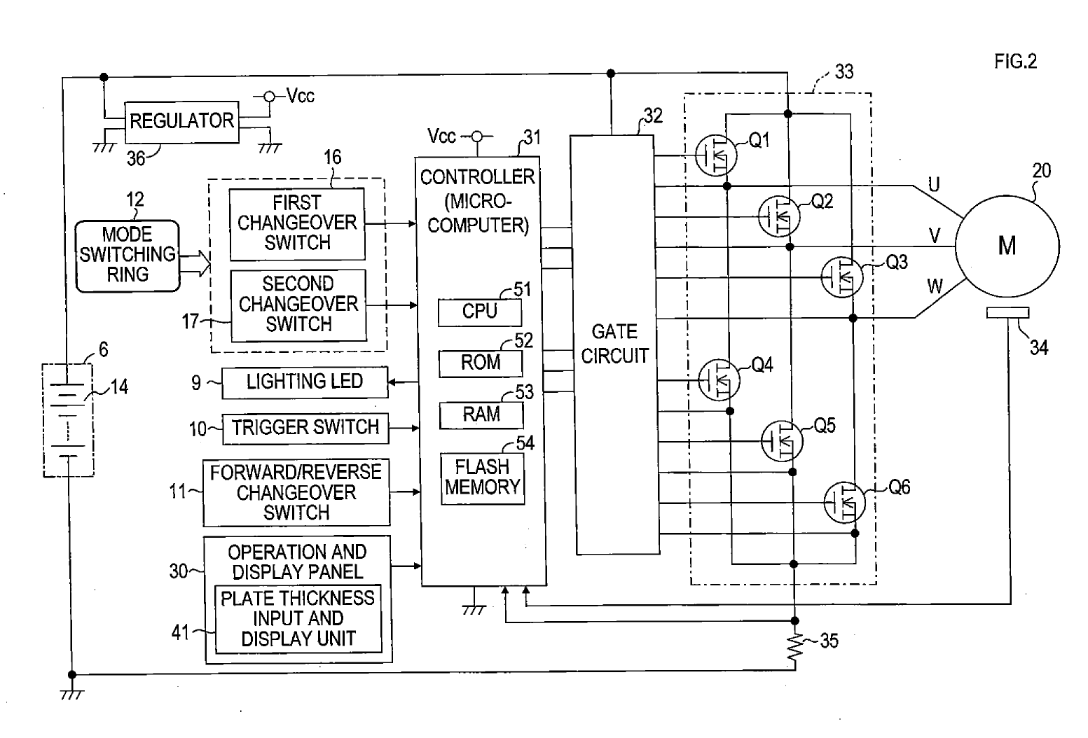

The battery pack 6 houses a battery 14. In the battery 14, secondary battery cells to generate a specified DC (direct-current) voltage are connected in series. The handle portion 4 houses a motor control device. The motor control device includes later-described controller 31, gate circuit 32, motor drive circuit 33, and the like (see FIG. 2). The motor control device operates, receiving power supply from the battery 14 in the battery pack 6, to rotate the motor 20 according to an operated amount of the trigger switch 10.

The motor 20 does not start rotation immediately after the trigger switch 10 is pulled only slightly; the motor 20 does not rotate until a specified amount (although a small amount) of pulling operation has been performed since the start thereof. When the pulling operation of the trigger switch 10 exceeds the specified amount, the motor 20 starts rotation, and then the rotation number (rotation speed) of the motor 20 is increased according to a pulled amount of the trigger switch 10 (for example, approximately in proportion to the pulled amount). When the trigger switch 10 is pulled to a specified position (for example, when the trigger switch 10 is fully pulled), the rotation number of the motor 20 reaches a preset maximum rotation number.

Above the trigger switch 10 in the main body housing 5, there is provided a lighting LED 9 to radiate light forward of the electric power tool 1. The lighting LED 9 is lit when a user operates the trigger switch 10.

There is also provided an operation and display panel 30 at a lower end of the handle portion 4. The operation and display panel 30 is designed to perform display of various information and reception of operation inputs, such as display of various set values and reception of setting change operations as well as display of a remaining capacity of the battery 14 in the electric power tool 1.

The operation and display panel 30 includes a plate thickness input and display unit 41 (not shown in FIG. 1; see FIG. 2). The plate thickness input and display unit 41 includes a setting switch with which a user sets (inputs) a plate thickness (material thickness) of a tightening-target-object, and a display portion on which a currently set value of the plate thickness is displayed.

The electric power tool 1 of the present embodiment has five operation modes, i.e., an impact mode (rotation and impact in a rotational direction), a vibration drill mode (rotation and impact in an axial direction), a drill mode (rotation only), a clutch mode (rotation and electronic clutch), and a TEKS mode (rotation and switching of rotation number). A user can set a desired operation mode by operating the mode switching ring 12.

Inside the main body housing 5, there are provided two changeover switches 16 and 17 (see FIG. 2) to be turned on/off according to a turning position of the mode switching ring 12 (that is, according to the set operation mode).

With the configuration as above, when a user turns the mode switching ring 12 to position a mark of the impact mode at the tip of the arrow 13 in order to set the operation mode to, for example, the impact mode, a transmission mechanism to transmit a rotational driving force of the motor 20 to the sleeve 8 is switched to a transmission mechanism corresponding to the impact mode (i.e., a mechanism that generates an impact force when a torque of a specified value or greater is applied) in the main body housing 5. At this time, both of the changeover switches 16 and 17 are off.

When a user turns the mode switching ring 12 to position a mark of the vibration drill mode at the tip of the arrow 13 in order to set the operation mode to, for example, the vibration drill mode, the transmission mechanism to transmit the rotational driving force of the motor 20 to the sleeve 8 is switched to a transmission mechanism corresponding to the vibration drill mode (i.e., a mechanism that generates an impact (vibration) in an axial direction while causing rotation) in the main body housing 5. At this time, a first changeover switch 16 of the changeover switches 16 and 17 becomes an on state, whereas a second changeover switch 17 becomes an off state.

When a user turns the mode switching ring 12 to position a mark of the drill mode at the tip of the arrow 13 in order to set the operation mode to, for example, the drill mode, the transmission mechanism to transmit the rotational driving force of the motor 20 to the sleeve 8 is switched to a transmission mechanism corresponding to the drill mode (a mechanism that transmits to the sleeve 8 the rotational driving force of the motor as it is or at a reduced speed) in the main body housing 5. At this time, the first changeover switch 16 of the changeover switches 16 and 17 becomes the on state, whereas the second changeover switch 17 becomes the off state.

When a user turns the mode switching ring 12 to position a mark of the clutch mode at the tip of the arrow 13 in order to set the operation mode to, for example, the clutch mode, the transmission mechanism to transmit the rotational driving force of the motor 20 to the sleeve 8 is switched to a transmission mechanism corresponding to the clutch mode (the same as the case of the drill mode) in the main body housing 5. At, this time, both of the changeover switches 16 and 17 become the on state.

In the clutch mode, the content of the control of the motor 20 are different from those in the drill mode, although the transmission mechanism is the same as that in the drill mode. Specifically, in the drill mode, the control is performed such that the rotational driving force is always generated while the pulling operation of the trigger switch 10 is performed. In contrast, in the clutch mode, the rotation of the motor 20 is stopped when the torque of the motor 20 reaches or exceeds a specified set torque value.

When a user turns the mode switching ring 12 to position a mark of the TEKS mode at the tip of the arrow 13 in order to set the operation mode to, for example, the TEKS mode, the transmission mechanism to transmit the rotational driving force of the motor 20 to the sleeve 8 is switched to a transmission mechanism corresponding to the TEKS mode (the same as that in the drill mode) in the main body housing 5. At this time, the second changeover switch 17 of the changeover switches 16 and 17 becomes the on state, whereas the first changeover switch 16 becomes the off state.

The TEKS mode is an operation mode in which mainly a self-drilling screw is an object to be tightened. As already described, a self-drilling screw is a screw that can be tightened while drilling a hole in a tightening-target-object, such as a steel plate.

In the TEKS mode, when starting tightening, the motor 20 is rotated at high speed with a specified first set rotation number N1 as an upper limit. Then, when a hole is drilled in the tightening-target-object, the upper limit of the rotation number is switched to a second set rotation number N2 that is lower than the first set rotation number N1. Further, after the self-drilling screw has been seated on the tightening-target-object, the motor 20 is stopped (or the upper limit of the rotation number is switched to a third set rotation number N3 that is lower than the second set rotation number N2). The contents of the control of the motor 20 in the TEKS mode will be described later.

Next, a description will be given of the motor control device provided inside the electric power tool 1 to control the rotational driving of the motor 20 with reference to FIG. 2. As shown in FIG. 2, the motor control device is designed to supply DC power from the battery 14 housed in the battery pack 6 to the motor 20 to thereby rotationally drive the motor 20. More specifically, the motor control device includes a controller 31, a gate circuit 32, a motor drive circuit 33, and a regulator 36.

The motor 20 of the present embodiment is configured as a three-phase brushless DC motor, and terminals U, V, and W of the motor 20 are connected to the battery pack 6 (more specifically, to the battery 14) through the motor drive circuit 33. Each of the terminals U, V, and W is connected to one of three not-shown coils provided to the motor 20 in order to rotate a not-shown rotor of the motor 20.

The motor drive circuit 33 is configured as a bridge circuit that includes three switching elements Q1 to Q3, which are so-called high-side switches that connect the respective terminals U, V, and W of the motor 20 to a positive electrode side of the battery 14; and three switching elements Q4 to Q6, which are so-called low-side switches that connect the respective terminals U, V, and W of the motor 20 to a negative electrode side of the battery 14. Each of the switching elements Q1 to Q6 in the present embodiment is a known MOSFET.

The gate circuit 32 is connected to the controller 31, and is also connected to respective gates and sources of the switching elements Q1 to Q6. The gate circuit 32 applies a switching voltage to turn on/off each of the switching elements Q1 to Q6 between the gate and source of each of the switching elements Q1 to Q6, based on a control signal that is inputted from the controller 31 to the gate circuit 32 in order to control on/off of each of switching elements Q1 to Q6, to thereby turn on/off each of the switching elements Q1 to Q6.

The regulator 36 reduces the DC voltage of the battery 14 to generate a control voltage Vcc (for example, 5 V), which is a specified DC voltage, and supplies the generated control voltage Vcc to various components, including the controller 31, in the motor control device.

The controller 31 of the present embodiment is configured, by way of example, as a so-called one-chip microcomputer, and includes a CPU 51, a ROM 52, a RAM 53, and a flash memory 54. The controller 31 also includes an input/output (I/O) port, an A/D converter, a timer, and the like.

The respective changeover switches 16 and 17, the lighting LED 9, the trigger switch 10, the forward/reverse changeover switch 11, the operation and display panel 30, a rotational position sensor 34 provided to the motor 20, and a shunt resistor 35 disposed in series in a conduction path of the motor 20 are connected to the controller 31.

The rotational position sensor 34 includes a Hall element and is configured to output a pulse signal to the controller 31 each time a rotational position of the rotor of the motor 20 reaches a specified rotational position (specifically, each time the motor 20 rotates a specified amount). Then, the controller 31 calculates the actual rotational position and rotation number of the motor 20 based on the pulse signal from the rotational position sensor 34, and uses the calculation result in motor control.

Electrical signals indicating respective states (on state or off state) of the changeover switches 16 and 17 are inputted from the changeover switches 16 and 17 to the controller 31. The controller 31 determines which operation mode the electric power tool 1 is set to, based on the inputted electrical signals, and controls the motor 20 by a control method based on the determination result.

In the present embodiment, three types of control methods, i.e., single-speed control, electronic clutch control, and TEKS control, of the motor 20 by the controller 31 are prepared. When the operation mode is set to the the impact mode, the drill mode, or the vibration drill mode, the controller 31 uses the single-speed control. When the operation mode is set to the clutch mode, the controller 31 uses the electronic clutch control. When the operation mode is set to the TEKS mode, the controller 31 uses the TEKS control.

The single-speed control is a control method in which the motor 20 is rotated at a rotation number according to a pulled amount (operated amount) of the trigger switch 10 by a user with a preset maximum rotation number (hereinafter, referred to as a “set rotation number”) as an upper limit.

The trigger switch 10 of the present embodiment more specifically includes a drive start switch to detect whether the trigger switch 10 is pulled and a known variable resistor (for example, a known potentiometer or the like) to detect the pulled amount of the trigger switch 10. When a pulling operation of the trigger switch 10 is performed, an analog signal according to the pulled amount of the trigger switch 10 is inputted from the trigger switch 10 to the controller 31.

Accordingly, in the case of the single-speed control, the controller 31 controls the motor 20 such that the motor 20 is rotated at the rotation number according to the pulled amount indicated by the analog signal that is inputted from the trigger switch 10. More specifically, the controller 31 sets duty ratios of voltages (driving voltages) to be applied to the respective terminals U, V, and W of the motor 20 through the gate circuit 32 and the motor drive circuit 33 such that the rotation number become larger as the pulled amount of the trigger switch 10 is larger, with the set rotation number as the upper limit. In the present embodiment, PWM control is performed, by way of example, such that the rotation number increases in proportion to the pulled amount of the trigger switch 10, and reaches the set rotation number when the pulled amount is maximum.

The electronic clutch control is a control in which the motor 20 is rotated at the rotation number according to the pulled amount of the trigger switch 10 basically in the same manner as in the single-speed control. In the electronic clutch control, a rotational torque of a tool bit (the rotational torque of the sleeve 8) is monitored, and rotation of the motor 20 is stopped when the rotational torque reaches or exceeds a specified set torque value.

In the present embodiment, the rotational torque of the tool bit is not detected directly; the rotational torque of the tool bit is detected indirectly by detecting an output torque of the motor 20. Specifically, a voltage at an end of a shunt resistor 35, which is provided in the conduction path of the motor 20, opposite to a ground potential side is inputted to the controller 31. The controller 31 detects the output torque of the motor 20 based on the voltage inputted from the shunt resistor 35.

The TEKS control is for the operation mode suitable for tightening of a self-drilling screw. In the TEKS control, PWM control of the motor 20 is performed at the rotation number according to the pulled amount of the trigger switch 10 with the set rotation number as the upper limit basically in the same manner as in the single-speed control. In addition to such basic control, the set rotation number is changed to three levels, i.e., N1, N2, and N3, in accordance with the progress of a tightening operation in the TEKS control, as described above.

Specifically, an initial set rotation number after the trigger switch 10 is turned on is set to the first set rotation number N1 that is relatively the highest. Setting such a high initial rotation number after the start-up of the motor allows a self-drilling screw to rapidly enter the tightening-target-object (that is, to rapidly drill a hole in the tightening-target-object).

When a hole is drilled in the tightening-target-object and a tip of the self-drilling screw enters the tightening-target-object (and, further, the operation has reached a stage to start tapping into the tightening-target-object), the set rotation number is reduced to the second set rotation number N2.

There may be various ways of specifically how to detect that a hole has been drilled in the tightening-target-object (i.e., that the operation has reached the stage to start tapping); however, determination is made based on changes in the rotation number of the motor 20 in the present embodiment.

In a period after tightening of a screw is started until the screw has entered the tightening-target-object, a tightening torque is relatively small, and thus the motor rotation number is large. When the tightening of the screw proceeds and a hole has been drilled in the tightening-target-object and the tip of the screw has entered the tightening-target-object, the tightening torque becomes larger, and the motor rotation number is reduced.

In the present embodiment, therefore, a hole drilling rotation number threshold Ns1 is previously set based on an assumed motor rotation number when a hole has been drilled in the tightening-target-object. Specifically, a rotation number lower than the first set rotation number N1 by a specified number is set as the hole drilling rotation number threshold Ns1. When the motor rotation number once reaches the first set rotation number N1 after the start-up of the motor 20, and then the motor rotation number reaches or falls below the hole drilling rotation number threshold Ns1, it is determined that a hole is drilled in the tightening-target-object, and the set rotation number is reduced to the second set rotation number N2.

Subsequently, when the tightening of the screw proceeds further, the screw will be seated on the tightening-target-object. If the screw is rotated at the same second set rotation number after the screw is seated, an excessive torque may be applied and damage the screw head, or the screw may idle causing defects in a screw hole in the tightening-target-object. In the present embodiment, therefore, the rotation of the motor 20 is stopped when seating of the screw is detected.

In the present embodiment, detection of seating is performed based on the motor rotation number in the same manner as detection of hole drilling. As the tightening of the screw proceeds after a change to the second set rotation number N2, tapping also proceeds, and thus the tightening torque gradually becomes larger and the motor rotation number gradually becomes lower.

In the present embodiment, therefore, a seating rotation number threshold Ns2 (<Ns1) is previously set based on an assumed motor rotation number when a screw is seated. Specifically, a rotation number lower than the second set rotation number N2 by a specified number is set as the seating rotation number threshold Ns2. When the motor rotation number reaches or falls below the seating rotation number threshold Ns2 after the change to the second set rotation number N2, it is determined that the screw is seated, and the rotation of the motor 20 is stopped.

However, to stop the rotation of the motor 20 after the screw is seated is merely an example. It may be configured to further reduce the set rotation number instead of stopping the rotation. Specifically, when seating of the screw is detected, the set rotation number is reduced to a third set rotation number N3.

Hereinafter, descriptions will be given, in a parallel manner, of both of a pattern (hereinafter also referred to as “Pattern A”) in which the rotation of the motor 20 is stopped after seating and a pattern (hereinafter also referred to as “Pattern B”) in which the set rotation number is reduced to the third set rotation number N3 after seating.

Specific values of the respective set rotation numbers N1, N2, and N3 as well as the respective rotation number thresholds Ns1 and Ns2 may be appropriately determined, for example, by experiments or by theoretical design, or the like. Taking the first set rotation number N1 as an example, it is possible to appropriately set, as the first set rotation number N1, a rotation number that allows a screw to enter the tightening-target-object rapidly and stably after starting the tightening, considering respective types of the tightening-target-object and the screw, the state of operation during the tightening operation by a user, etc. that are expected at the time of tightening.

The magnitude relation among the aforementioned three set rotation numbers N1, N2, and N3, and the aforementioned two rotation number thresholds Ns1 and Ns2 is N1>Ns1>N2>Ns2>N3.

Detection of seating performed based on the motor rotation number is merely an example, and detection of seating may be performed by another method. Specifically, detection may be performed, for example, based on motor current. As the tightening of a screw proceeds, the tightening torque gradually increases, and thus the motor current gradually increases. It is, therefore, possible to set a first current threshold based on an assumed value of the motor current when the screw is seated, and to determine that the screw is seated when the motor current reaches or exceeds the first current threshold. The motor current may be detected based on a voltage inputted from the shunt resistor 35 and a resistance value of the shunt resistor 35.

Also, detection of hole drilling based on the motor rotation number is merely an example, and detection may be performed, for example, based on the motor current. Specifically, it is possible to set a second current threshold (>the first current threshold) based on an assumed value of the motor current when a hole is drilled in the tightening-target-object, and to determine that a hole has been drilled in the tightening-target-object when the motor current reaches or exceeds the second current threshold.

It may, of course, be possible to detect either hole drilling or seating by another detection method other than the aforementioned detection method based on the motor rotation number or on the motor current.

Further, in the TEKS mode, it is configured such that a user can set the plate thickness of the tightening-target-object, and the respective set rotation numbers N1, N2, and N3 as well as the respective rotation number threshold Ns1 and Ns2 can be variably set according to the set plate thickness.

As described above, the operation and display panel 30 of the electric power tool 1 includes the plate thickness input and display unit 41 for setting input of the plate thickness and for displaying the plate thickness. A user can set a desired plate thickness by operating the plate thickness input and display unit 41.

In the present embodiment, the plate thickness may be set to one of five levels “A”, “B”, “C”, “D”, and “E”, by way of example. The relative relationship among these plate thickness set values A to E is as follows: the plate thickness set value A corresponds to the smallest plate thickness; B, C, and D correspond to respective sequentially increased plate thicknesses; and E corresponds to the largest plate thickness.

Accordingly, in a case where the tightening-target-object has a very small thickness, (for example, plate thickness t [mm]≦a [mm]), appropriate tightening operation according to the plate thickness can be performed by setting the plate thickness set value to “A”. Similarly, in a case where the tightening-target-object has a thickness that is relatively small but larger than a [mm] (for example, a [mm]<plate thickness t [mm]<b [mm]), appropriate tightening operation according to the plate thickness can be performed by setting the plate thickness set value to “B”. In a case where the tightening-target-object has an intermediate thickness (for example, b [mm]<plate thickness t [mm]≦c [mm]), appropriate tightening operation according to the plate thickness can be performed by setting the plate thickness set value to “C”. In a case where the tightening-target-object has a relatively large thickness (for example, c [mm]<plate thickness t [mm]≦d [mm]), appropriate tightening operation according to the plate thickness can be performed by setting the plate thickness set value to “D”. In a case where the tightening-target-object has a very large thickness (for example, plate thickness t [mm]>d [mm]), appropriate tightening operation according to the plate thickness can be performed by setting the plate thickness set value to “E”. When tightening a self-drilling screw or the like in the TEKS mode, a user can selectively set one of the five types of plate thickness set values based on the thickness of the tightening-target-object into which the screw is tightened.

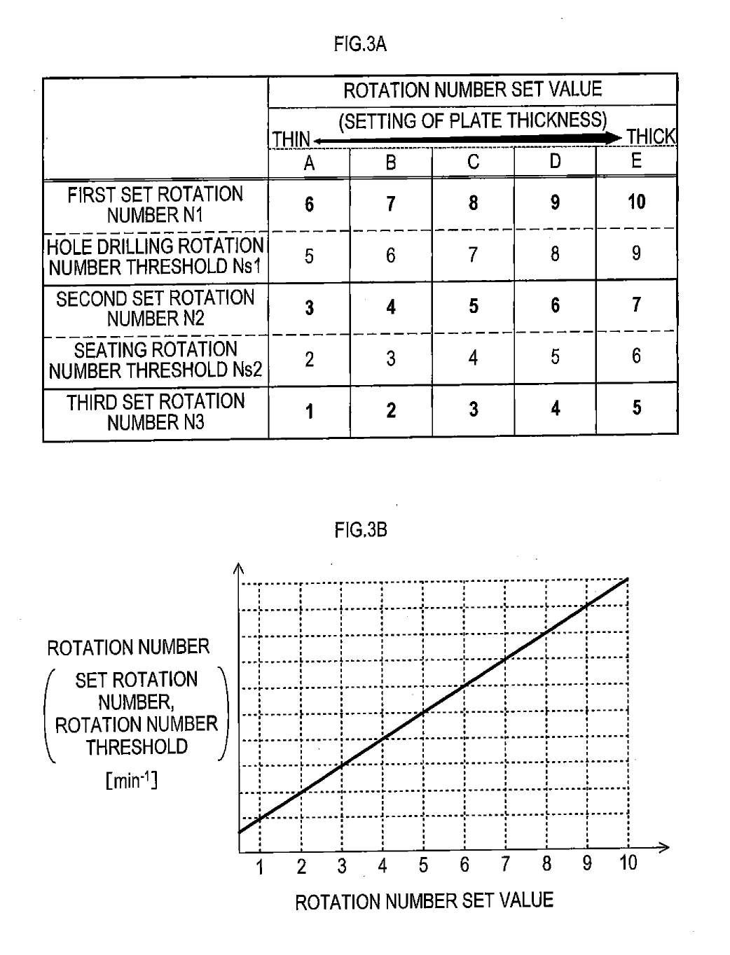

Once a user sets the plate thickness, the respective set rotation numbers N1, N2, and N3 as well as the respective rotation number thresholds Ns1 and Ns2 are set in the electric power tool 1 according to the set plate thickness. The relationship between each of the above values and the plate thickness is as shown in FIGS. 3A-3B.

As shown in 3A, in the present embodiment, each of the set rotation numbers N1, N2, and N3 as well as the rotation number thresholds Ns1 and Ns2 is set to one of the rotation number set values 1-10 according to the plate thickness. For example, in the case of the first set rotation number N1, the rotation number set values “6”, “7”, “8”, “9”, and “10” respectively correspond to the plate thicknesses “A” to “E”.

The correspondence relationship between the rotation number set values and respective actual rotation numbers is as shown in FIG. 3B: the rotation number becomes larger as the rotation number set value is larger. Accordingly, the first set rotation number N1 is set to a lower value as the plate thickness set value is smaller (i.e., becoming smaller from “E” toward “A”).

In the case of the second set rotation number N2, the rotation number set values “3”, “4”, “5”, “6”, and “7” respectively correspond to the plate thicknesses “A” to “E”. Accordingly, the second set rotation number N2 is also set to a lower value as the plate thickness set value is smaller. However, the magnitude relation of the second set rotation number N2 and the first set rotation number N1 at the same plate thickness set value is N2<N1.

In the case of the third set rotation number N3, the rotation number set values “1”, “2”, “3”, “4”, and “5” respectively correspond to the plate thicknesses “A” to “E”. Accordingly, the third set rotation number N3 is also set to a lower value as the plate thickness set value is smaller. The magnitude relation of the third set rotation number N3 and the second set rotation number N2 at the same plate thickness set value is N3<N2.

In the case of the hole drilling rotation number threshold Ns1, the rotation number set values “5”, “6”, “7”, “8”, and “9” respectively correspond to the plate thicknesses “A” to “E”. Accordingly, the hole drilling rotation number threshold Ns1 is also set to a lower value as the plate thickness set value is smaller. However, the magnitude relation of the hole drilling rotation number Ns1 and the first set rotation number N1 at the same plate thickness set value is Ns1<N1, and the hole drilling rotation number Ns1 is set to a value that is slightly lower (i.e., one level lower, when converted to the set level of the rotation number set value) than the first set rotation number N1 in the present example.

In the case of the seating rotation number threshold Ns2, the rotation number set values “2”, “3”, “4”, “5” and “6” respectively correspond to the plate thicknesses “A” to “E”. Accordingly, the seating rotation number threshold Ns2 is also set to a lower value as the plate thickness set value is smaller. However, the magnitude relation of the seating rotation number threshold Ns2 and the second set rotation number N2 at the same plate thickness set value is Ns2<N2, and the seating rotation number threshold Ns2 is set to a value that is slightly lower (i.e., one level lower, when converted to the set level of the rotation number set value) than the second set rotation number N2 in the present example.

The values (rotation number set values) of the set rotation numbers N1, N2, and N3 as well as the rotation number thresholds Ns1 and Ns2 corresponding to the five levels of the plate thickness set value as shown in FIG. 3A; and the correspondence relationship between the rotation number set values and the rotation number as shown in FIG. 3B are previously stored as maps in the ROM 52 or the flash memory 54 in the controller 31. The controller 31 refers to the maps with respect to a plate thickness that is set by a user, and reads the aforementioned respective values that correspond to the set plate thickness. Then, the controller 31 performs motor control using the read respective values.

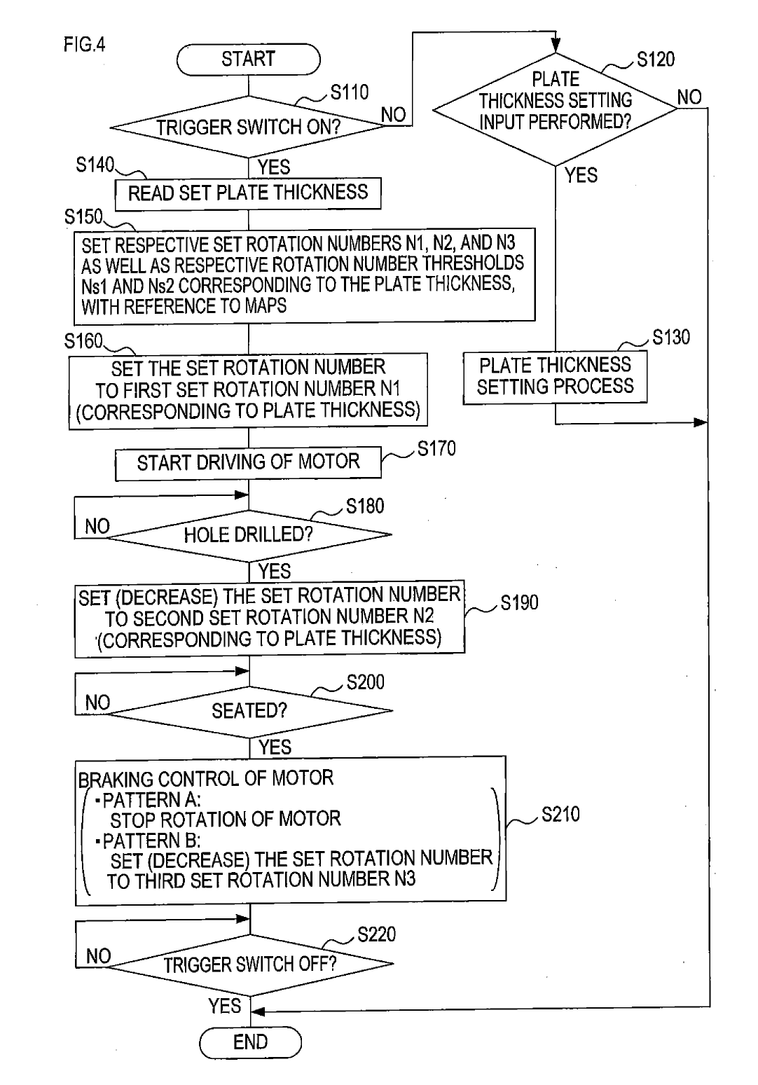

Next, a description will be given, with reference to FIG. 4, of a motor control process to be executed when the operation mode is set to the TEKS mode, among various control processes that the controller 31 executes. The ROM 52 (or the flash memory 54) in the controller 31 stores a program for the motor control process shown in FIG. 4. When power is supplied, the CPU 51 starts operation and periodically executes the motor control process.

When starting the motor control process, the CPU 51 in the controller 31 first determines in S110 whether the trigger switch 10 is on. If the trigger switch 10 is off, the present process proceeds to S120, in which it is determined whether a plate thickness setting input by a user has been performed. If a plate thickness setting input has not been performed, the present motor control process is terminated. If a plate thickness setting input has been performed through the plate thickness input and display unit 41, a plate thickness setting process is executed in S130. Specifically, the plate thickness set value is set to one of the five levels “A” to “E” according to the specifics of the user's operation input.

If it is determined in S110 that the trigger switch 10 is on, the currently set plate thickness (the plate thickness set value) is read in S140. Then in S150, the respective set rotation numbers N1, N2, and N3 as well as the respective rotation number thresholds Ns1 and Ns2 corresponding to the plate thickness are read and set, with reference to the maps shown in FIGS. 3A to 3B. Specifically, regarding the set rotation numbers N1, N2, and N3 as well as the rotation number thresholds Ns1 and Ns2, respective rotation number set values corresponding to the currently set plate thickness are read from the map in FIG. 3A. Then, respective rotation numbers corresponding to the read rotation number set values are read from the map in FIG. 3B, and the read respective rotation numbers are set. As a result, the respective values (N1, N2, N3, Ns1, and Ns2) set in S150 are used in processes from S160 onward, that is, in actual control of the motor 20.

In S160, the set rotation number is set to the first set rotation number N1 that is set in S150. Specifically, among the respective rotation numbers (see FIG. 3B) corresponding to the rotation number set values “6” to “10”, the rotation number corresponding to the currently set plate thickness is set as the first set rotation number N1. Then in S170, the motor 20 is started driving at the first set rotation number N1.

After the motor is started driving, it is determined in S180 whether a hole has been drilled in the tightening-target-object. Specifically, it is determined whether the motor rotation number has once reached the first set rotation number N1, and then the motor rotation number has reached or fallen below the hole drilling rotation number threshold Ns1 corresponding to the currently set plate thickness. If the motor rotation number has reached or fallen below the hole drilling rotation number threshold Ns1, it is determined that a hole has been drilled in the tightening-target-object, and the present process proceeds to S190.

In S190, the set rotation number is set to the second set rotation number N2 that is set in S150. Specifically, among the respective rotation numbers (see FIG. 3B) corresponding to the rotation number set values “3” to “7”, the rotation number corresponding to the currently set plate thickness is set as the second set rotation number N2. As a result, the motor 20 is driven at the second set rotation number N2.

After the change to the second set rotation number N2, it is determined in S200 whether a screw has been seated. Specifically, it is determined whether the motor rotation number has reached or fallen below the seating rotation number threshold Ns2 corresponding to the currently set plate thickness. If the motor rotation number has reached or fallen below the seating rotation number threshold Ns2, it is determined that the screw has been seated, and the present process proceeds to S210.

In S210, braking control of the motor 20 is performed. Specifically, rotation of the motor 20 is stopped in the case of Pattern A. In the case of Pattern B, the set rotation number is set to the third set rotation number N3 that is set in S150. More specifically, among the respective rotation numbers (see FIG. 3B) corresponding to the rotation number set values “1” to “5”, the rotation number corresponding to the currently set plate thickness is set as the third set rotation number N3. In other words, the motor 20 continues to be driven at the third set rotation number N3 even after the seating in Pattern B. When Pattern A is employed as an operation pattern after the seating, it is not necessary to set the third set rotation number N3 in the process in S150.

Subsequent to the braking control in S210, it is determined in S220 whether the trigger switch 10 is off. If the trigger switch 10 is off, the present motor control process is terminated.

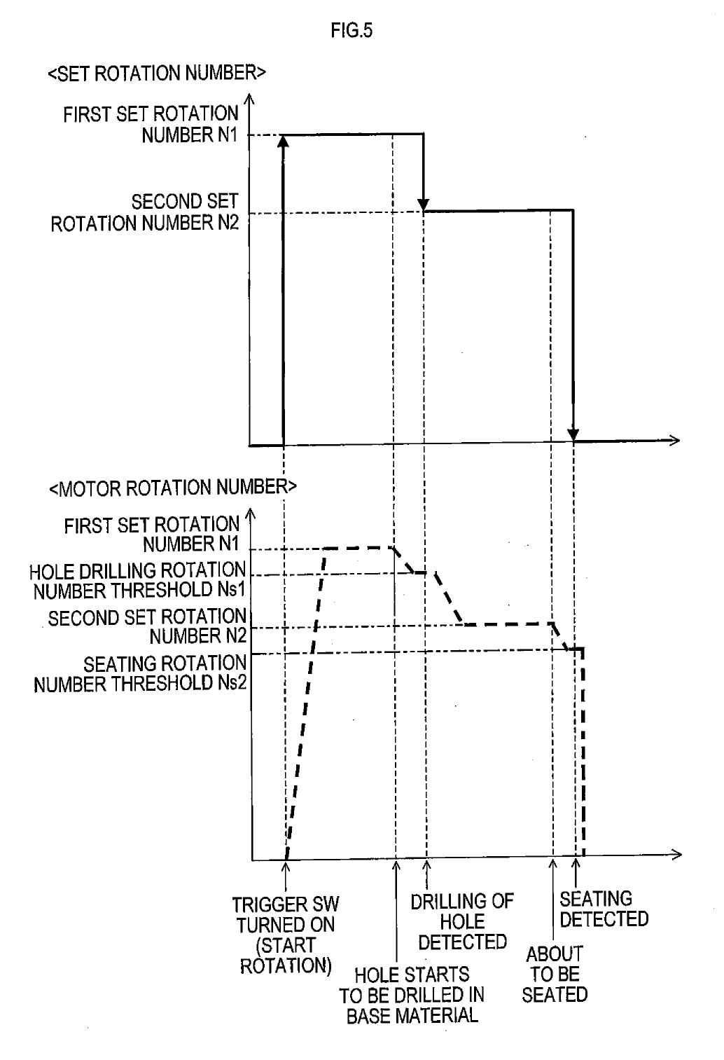

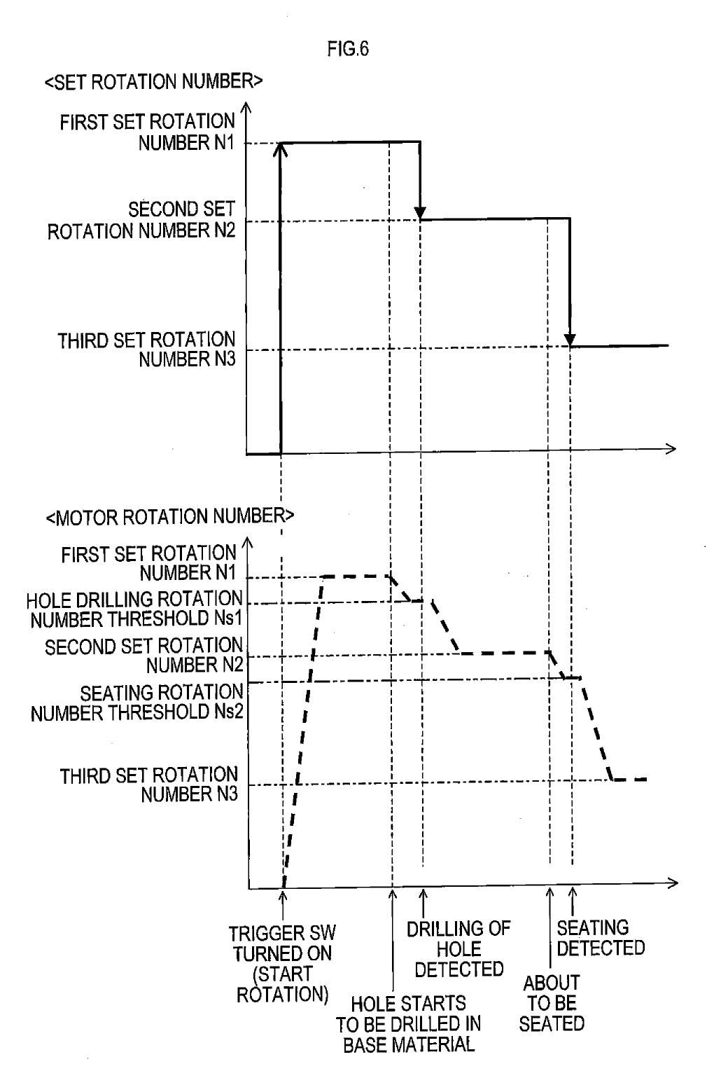

Examples of changes in the actual rotation number of the motor 20 and the respective set rotation numbers when the motor 20 is controlled in the aforementioned motor control process are shown in FIG. 5 and FIG. 6. FIG. 5 shows an example of Pattern A, whereas FIG. 6 shows an example of Pattern B. Each of the examples shown in FIG. 5 and FIG. 6 is on the condition that the trigger switch 10 is pulled maximally while the motor 20 rotates because the trigger switch 10 is on.

In the case of Pattern A, as shown in FIG. 5, when the trigger switch 10 is turned on, the set rotation number is set to the first set rotation number N1, and the rotation number of the motor 20 increases to eventually reach the first set rotation number N1. Subsequently, when a hole is started to be drilled in the tightening-target-object, the tightening torque gradually increases, causing a gradual decrease in the motor rotation number. When the motor rotation number reaches or falls below the hole drilling rotation number threshold Ns1, it is detected that a hole has been drilled in the tightening-target-object, and thereby the set rotation number is changed over to the second set rotation number N2.

When the set rotation number is changed over to the second set rotation number N2, the motor rotation number gradually decreases to eventually reach the second set rotation number N2. Subsequently, when the screw is about to be seated, the tightening torque further increases, causing a gradual decrease in the motor rotation number. When the motor rotation number has reached or fallen below the seating rotation number threshold Ns2, it is detected that the screw has been seated, and thereby rotation of the motor 20 is stopped.

In the case of Pattern B, as shown in FIG. 6, the changes are exactly the same as in the case of Pattern A shown in FIG. 5 until seating of the screw is detected. When seating of the screw is detected, the set rotation number is changed over to the third set rotation number N3. As a result, the motor rotation number gradually decreases to eventually reach the third set rotation number N3. Although it is not shown, when tightening of the screw proceeds after seating of the screw, the tightening torque further increases. Accordingly, even though the set rotation number is set to the third set rotation number N3, the actual motor rotation number further decreases to eventually make the motor stop.

According to the electric power tool 1 of the present embodiment as described above, the initial first set rotation number N1 after the trigger switch 10 is turned on is set to a lower value as the plate thickness is smaller. Accordingly, it is possible to have desirable workability and finishing state after a hole is drilled in a thin tightening-target-object, whereas it is possible to rapidly drill a hole in a thick tightening-target-object (and thus to rapidly proceed tightening operation).

Originally, it is desirable to set as high a set rotation number as possible so as to drill a hole sooner until a hole is drilled. However, when drilling a hole, by high-speed rotation, in a tightening-target-object having a small plate thickness, there is a possibility that the screw keeping the high-speed rotation penetrates the tightening-target-object after a hole is drilled and causes defects in a screw hole in the tightening-target-object depending on the rotation number, a time difference from the drilling of the hole to the detection thereof, and the like. Accordingly, it is preferable to lower the initial first set rotation number N1 when the plate thickness is small in view of the workability and finishing state after a hole is drilled.

Also, according to the electric power tool 1 of the present embodiment, the second set rotation number N2 after a hole has been drilled in the tightening-target-object and the third set rotation number N3 after the seating are set to respective lower values as the plate thickness is smaller. Accordingly, as for a thin tightening-target-object, it is possible to inhibit occurrence of defects, such as damage of a screw hole in the tightening-target-object, to obtain a good finishing state, whereas as for a thick tightening-target-object, it is possible to rapidly drill a hole therein (and thus to rapidly proceed tightening operation). In other words, by rotating the motor 20 at an appropriate set rotation number corresponding to the progress of a tightening operation and also at a further appropriate set rotation number corresponding to the plate thickness, it is possible to appropriately perform the tightening operation of a screw into a tightening-target-object regardless of the plate thickness, and thereby an improved general workability can be achieved.

After the seating of a screw, the motor 20 may be completely stopped as in Pattern A, or the set rotation number may be decreased to the third set rotation number N3 as in Pattern B. In either pattern, it is possible to inhibit a screw from being tightened with an excessively large force after being seated, to thereby finish the tightening operation in a proper state.

In the present embodiment, the trigger switch 10 corresponds to an example of an operation receiving unit of present invention; the plate thickness input and display unit 41 corresponds to an example of a material thickness receiving unit of the present invention; and the controller 31 corresponds to an example of a motor control unit, a first maximum rotation number setting unit, a second maximum rotation number setting unit, a third maximum rotation number setting unit, a first maximum rotation number variable setting unit, a second maximum rotation number variable setting unit, a third maximum rotation number variable setting unit, a hole drilling detection unit, and a seating detection unit of the present invention. The first set rotation number N1 corresponds to an example of a first maximum rotation number of the present invention; the second set rotation number N2 corresponds to an example of a second maximum rotation number of the present invention; and the third set rotation number N3 corresponds to an example of a third maximum rotation number of the present invention.

Also, in the motor control process in FIG. 4, the process in S150 corresponds to an example of a process to be executed by the first maximum rotation number variable setting unit, the second maximum rotation number variable setting unit, and the third maximum rotation number variable setting unit of the present invention; the process in S160 corresponds to an example of a process to be executed by the first maximum rotation number setting unit of the present invention; the process in S190 corresponds to an example of a process to be executed by the second maximum rotation number setting unit of the present invention; the process in S210 (only in a pattern in which the set rotation number is decreased to the third set rotation number N3) corresponds to an example of a process to be executed by the third maximum rotation number setting unit of the present invention; the process in S180 corresponds to an example of a process to be executed by the hole drilling detection unit of the present invention; and the process in S200 corresponds to an example of a process to be executed by the seating detection unit of the present invention.

### MODIFIED EXAMPLES

Although an embodiment of the present invention has been described above, it is obvious that embodiments of the present invention should not at all be limited to the above described, but may be in various forms within the technical scope of the present invention.

For example, although the above described embodiment shows an example in which all of the set rotation numbers N1, N2, and N3 are variably set according to the plate thickness, only one or two of the set rotation numbers may be variably set. The same is applicable to the rotation number thresholds Ns1 and Ns2.

Also, although the plate thickness (the plate thickness set value) can be set to the five levels “A” to “E” in the above described embodiment, it is merely an example that the plate thickness can be set to the five levels, and the plate thickness may be set to two levels, or four levels or more.

Further, in the configuration in which the plate thickness can be set to a plurality of levels, the set rotation numbers N1, N2, and N3 are not required to be respectively different values for the respective levels of the plate thickness. For example, it may be configured such that, when the plate thickness set value is any of “C” to “E”, the set rotation numbers are the same; when the plate thickness set value is “B”, the set rotation number is lower; and when the plate thickness set value is “A”, the set rotation number is lower than in the case of “B”. The same is applicable to the rotation number thresholds Ns1 and Ns2.

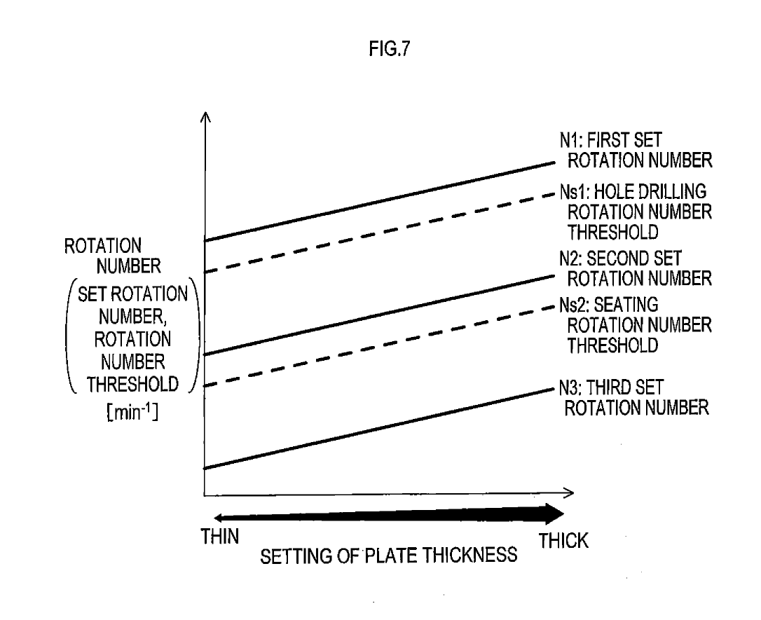

Moreover, setting of the plate thickness is not limited to stepwise setting as in the above described embodiment, but the plate thickness may be set in a continuous manner (analog manner) by means of various setting operation methods, such as dial operation or level operation. In the configuration in which the plate thickness can be set in a continuous manner, there may be various ways of specifically setting the respective set rotation numbers N1, N2, N3 and the respective rotation number thresholds Ns1 and Ns2 according to the plate thickness set value. For example, as shown in FIG. 7, it may be possible to set the respective values such that each of the respective values continuously changes with respect to the plate thickness.

In this case, it may be configured such that a map of a correspondence relationship as shown in FIG. 7 is prepared in advance, and the respective set rotation numbers N1, N2, and N3 as well as the respective rotation number thresholds Ns1 and Ns2 corresponding to the set plate thickness are read using the map and then are used.

Although FIG. 7 shows an example, for simplified description, in which each of the set rotation numbers N1, N2, and N3, etc. changes linearly with respect to the plate thickness, this is merely an example; the numbers, etc. may change non-linearly. Also, using maps as shown in FIGS. 3A-3B and FIG. 7 is merely an example; the respective values may be obtained by means of an approach other than a map, such as obtaining the respective set rotation numbers N1, N2, and N3, etc. by a specified numerical calculation based on the plate thickness.

It may be configured such that only the set rotation numbers N1, N2, and N3 are variably set according to the plate thickness, whereas the rotation number thresholds Ns1 and Ns2 are respective constant values regardless of the plate thickness. In this case, the hole drilling rotation number threshold Ns1 may be set to a value that is lower than the first set rotation number N1 among the initial first set rotation numbers N1 in the case where the plate thickness is the smallest (i.e., in the case where the plate thickness set value is “A”). Also, the seating rotation number threshold Ns2 may be set to a value that is lower than the second set rotation number N2 among the second set rotation numbers N2 after a hole is drilled in the case where the plate thickness is the smallest (i.e., in the case where the plate thickness set value is “A”).

Further, in terms of the motor control after seating, a motor control method may be selected according to the plate thickness. For example, it may be configured such that the motor 20 is stopped as in Pattern A when the plate thickness is small, whereas the motor 20 is rotated at the third set rotation number N3 as in Pattern B when the plate thickness is large.

It may be configured such that the set rotation number at the time of start-up gradually increases from zero to the first set rotation number N1 instead of being immediately set to the first set rotation number N1.

Also, an operation example in the TEKS mode may include application of an impact. Specifically, it may be configured such that an impact mechanism is used as the transmission mechanism in the TEKS mode, and thereby an impact action is started when the tightening torque is increased also in the TEKS mode.

The application of the present invention of course should not be limited to the aforementioned 5-mode impact driver, and the present invention may be applicable to various electric power tools to be used for screw tightening operation. By applying the present invention, it is possible to suitably tighten a screw, such as a self-drilling screw or a wood screw, which is tightened while the screw itself is drilling a hole in the tightening-target-object.

1. An electric power tool to tighten a screw while drilling a hole with the screw in a tightening-target-object, the electric power tool comprising:
a motor configured to rotationally drive an output shaft on which a tool element is mounted;
an operation receiving unit configured to receive an external operation input to rotate the motor;
a material thickness receiving unit configured to receive a material thickness that is a thickness of the tightening-target-object;
a motor control unit configured to control the motor such that the motor rotates at a rotation number according to specifics of the operation input received by the operation receiving unit with a preset maximum rotation number as an upper limit;
a first maximum rotation number setting unit configured to set the maximum rotation number to a specified first maximum rotation number at a start-up of the motor;
a hole drilling detection unit configured to detect that a hole has been drilled in the tightening-target-object with the screw after the start-up of the motor;
a second maximum rotation number setting unit configured to set, when it is detected by the hole drilling detection unit that a hole has been drilled, the maximum rotation number to a specified second maximum rotation number that is lower than the first maximum rotation number; and
a second maximum rotation number variable setting unit configured to set the second maximum rotation number according to the material thickness such that the second maximum rotation number becomes lower as the material thickness received by the material thickness receiving unit is smaller.

2. The electric power tool according to claim 1, further comprising:
a seating detection unit configured to detect that the screw rotated by the tool element has been seated on the tightening-target-object,
wherein the motor control unit stops the motor when it is detected by the seating detection unit that the screw has been seated after the start-up of the motor.

3. The electric power tool according to claim 1, further comprising:
a seating detection unit configured to detect that the screw rotated by the tool element has been seated on the tightening-target-object; and
a third maximum rotation number setting unit configured to set, when it is detected by the seating detection unit that the screw has been seated after the maximum rotation number is set to the second maximum rotation number by the second maximum rotation number setting unit, the maximum rotation number to a specified third maximum rotation number that is lower than the second maximum rotation number.

4. The electric power tool according to claim 3, further comprising:
a third maximum rotation number variable setting unit configured to set the third maximum rotation number according to the material thickness such that the third maximum rotation number becomes lower as the material thickness received by the material thickness receiving unit is smaller.

5. The electric power tool according to claim 1, further comprising:
a first maximum rotation number variable setting unit configured to set the first maximum rotation number according to the material thickness such that the first maximum rotation number becomes lower as the material thickness received by the material thickness receiving unit is smaller.
